(19) United States
(12) Patent Application Publication
(10) Pub. No.: US 2006/0158476 A1
(43) Pub. Date: Jul. 20, 2006

(54) Method and system for aligning ink ejecting elements in an image forming device

(76) Inventors: Hun Yang NG, Singapore (SG); Karsten N. Wilson, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/040,045

(22) Filed: Jan. 20, 2005

(51) Int. Cl. B41J 29/393; B41J 2/12

(52) U.S. Cl. 347/19; 347/78

(57) ABSTRACT

In an embodiment, a method for aligning ink ejecting elements in an image forming device is provided. A reference pattern is printed onto a first portion of a print medium by a first ink injecting element, and an offset pattern is printed onto a second portion of the print medium by a second ink injecting element. The first portion of the print medium coincides with the second portion, and a combined pattern is formed from the reference pattern and the offset pattern. A portion of the combined pattern is scanned to generate a first response. Print medium noise, which corresponds to a thickness variation of the print medium, is removed from the first response to form a second response. The second ink ejecting element is aligned to the first ink ejecting element based on the second response.

### FIELD OF THE INVENTION

The invention relates generally to printing devices, and more particularly, to a method and system for aligning ink ejecting elements of an image forming device.

### BACKGROUND OF THE INVENTION

Printing devices, in particular inkjet printing devices such as printers, plotters, photocopiers or facsimile machines, typically use one or more inkjet cartridges or “pens” for printing. During a printing operation, a print medium, for example paper, is advanced (“paper-axis”) and the pen is scanned in a direction orthogonal to the paper axis (“scan-axis”). As the pen is scanned over the paper, drops of ink are shot onto the paper. The ink drop direction from the pen to the paper is referred to as the “swath axis”.

Each pen includes a printhead which normally has columns of ink nozzles. The nozzles fire drops of ink onto the paper to create printed dots as the pen is scanned across the paper. Each nozzle is used to address a particular vertical column position on the paper. Horizontal positions on the paper are addressed by repeatedly firing the nozzle as the pen is scanned across the paper. Each position is referred to as a pixel.

A color printer has more than one pen of different colors. The pens are mounted in stalls within a carriage assembly of the printer. To print a desired color on a specific pixel location, drops of ink are fired from a corresponding nozzle of each pen onto the specific pixel location to obtain the desired color.

High resolution printing requires that drops of ink from each nozzle of the pens be precisely applied on to the paper. This requires precise alignment of the nozzles in each pen and also between the different pens in the printer. However, mechanical misalignment of the nozzles and the pens results in offsets of the drops of ink printed on the paper. The offset of the ink printed on the paper results in printed images to be distorted. Mechanical misalignment is often due to tolerances and variations of mechanical parts of the pen and the printer, which typically includes physical location of the nozzles, curvature of the platen of printhead, height of the pen from the paper, spacing between the pens, and nozzle shape.

Other types of misalignment resulting in offset of the ink printed on the paper include drop placement errors due to firing timing of ink from the nozzles and directional errors due to movement of the printhead or pen (Scan Axis Directionality or “SAD” error) or movement of the paper (Paper Axis Directionality or “PAD” error).

Printers normally align their inkjet pens to correct any misalignment of the pens. Usually a group of nozzles of an inkjet pen is taken to be a reference group of nozzles, and other groups of nozzles are aligned to the reference group of nozzles. Similarly for pen-to-pen alignment, one of the pens is taken to be a reference pen, and the other pens are aligned to the reference pen. For a color printer, a black color pen is usually taken to be the reference pen.

A conventional method for pen alignment includes printing a reference pattern using the reference group of nozzles or the reference pen. A test pattern is subsequently printed in a predetermined relation with the reference pattern using the other groups of nozzles or pens. A user visually inspects the relation between the two patterns and determines a respective offset value to align the pens. It is also possible to scan the reference pattern and the test patterns using an optical scanner to determine the respective offset value. In this case, the pen alignment is performed automatically instead of a manual inspection of the patterns by the user.

A known method for automatic pen alignment includes printing a series of test patterns on a single sheet of paper. The series of test patterns are optically readable and allow misalignment errors to be detected.

A more accurate method for performing automatic pen alignment compared to the known methods is desired

### SUMMARY OF THE INVENTION

In an embodiment, a method for aligning ink ejecting elements in an image forming device is provided. A reference pattern is printed onto a first portion of a print medium by a first ink injecting element, and an offset pattern is printed onto a second portion of the print medium by a second ink injecting element. The first portion of the print medium coincides with the second portion, and a combined pattern is formed from the reference pattern and the offset pattern. A portion of the combined pattern is scanned to generate a first response. Print medium noise, which corresponds to a thickness variation of the print medium, is removed from the first response to form a second response. The second ink ejecting element is aligned to the first ink ejecting element based on the second response.

### BRIEF DESCRIPTION OF THE DRAWINGS

The embodiments of the invention will be better understood in view of the following drawings and the detailed description.

FIG. 1 shows a flow chart for aligning a group of test nozzles to a group of reference nozzles according to an embodiment of the invention.

FIG. 2A shows a reference pattern printed by reference nozzles of a pen.

FIG. 2B shows two combined patterns printed separately using two different color pens.

FIG. 3 shows a reference pattern and 3 different combined patterns for a misalignment of 0, +1 and −1.

FIG. 4 shows a graphical representation of the reflectivity of the combined patterns of four different color pens.

FIG. 5 shows a graphical representation of a difference in reflectivity of a cyan pen obtained from a difference between the reflectivity of the reference pattern and the combined pattern according to an embodiment of the invention.

FIG. 6 shows a graphical representation of the difference in reflectivity of 4 different color pens according to an embodiment of the invention.

FIG. 7 shows a flow chart for aligning a test pen to a reference pen according to an embodiment of the invention.

FIG. 8 shows a combined pattern printed using two pens having different colors.

FIG. 9 shows a graphical representation of the reflectivity of 3 different color pens obtained from scanning the respective combined pattern of each pen.

FIG. 10 shows a graphical representation of the difference in reflectivity of 3 different color pens according to an embodiment of the invention.

FIG. 11 shows a graphical representation of two responses which are obtained from the summation of a series of edge response obtained by scanning the respective combined patterns of FIG. 2B.

FIG. 12 shows a graphical representation of FIG. 11 with both responses scaled to the same size.

### DETAILED DESCRIPTION OF THE INVENTION

An embodiment of the invention is illustrated using a printer, in particular, an inkjet color printer. The inkjet color printer includes one or more inkjet cartridges or pens of different color. Each pen has columns of nozzles for ejecting droplets of ink onto a print medium such as paper. The colors of the pens include black, cyan, magenta and yellow. It is also possible to use other color pens for the printer.

In one embodiment, one group of nozzles of an inkjet pen (referred to as test nozzles) is aligned to another group of nozzles of the same inkjet pen (referred to as reference nozzles). This is called Intra-Pen alignment. Although the Intra-Pen alignment is described as aligning a group of test nozzles to a group of reference nozzles, it is also possible to align a single test nozzle to a single reference nozzle in another embodiment.

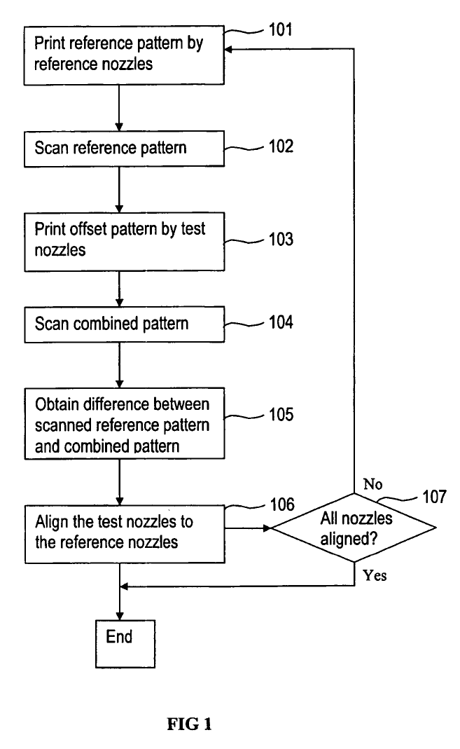

FIG. 1 shows a flow chart of an embodiment for Intra-Pen alignment. Step 101 includes printing a reference pattern on a paper using the reference nozzles of a black pen.

Step 102 includes scanning the reference pattern using an optical scanner to determine a reflectivity of the reference pattern. The optical scanner uses a blue light emitting diode (LED). Other color LEDs may be used in the optical scanner in other embodiments. The shape or thickness variation of the portion of the paper which the reference pattern is printed on also affects the reflectivity of the reference pattern detected by the optical scanner.

Step 103 includes printing an offset pattern on the paper using the test nozzles. The offset pattern coincides with the reference pattern to form a combined pattern. Step 104 includes scanning the combined pattern using the optical scanner to detect the reflectivity of the combined pattern.

Step 105 includes obtaining a difference in reflectivity between the reference pattern and the combined pattern. The difference in reflectivity can be obtained by subtracting the reflectivity of the combined pattern from the reference pattern.

Step 106 includes aligning the test nozzles to the reference nozzles based on the difference in reflectivity between the reference pattern and the combined pattern. The aligning of the test nozzles to the reference nozzles will be described in detail later.

After aligning the test nozzles to the reference nozzles, it is determined at step 107 whether all the nozzles in the inkjet pen are aligned. If not all the nozzles are aligned to the reference nozzles, steps 101 to 106 are repeated to align another group of test nozzles. If all the nozzles are aligned, the aligning of the nozzles of the pen is complete. Steps 101 to 106 may be repeated to align the nozzles of another pen.

Although the scanning of the combined pattern is described to be performed directly after printing each combined pattern, it is also possible to print all the combined patterns for all the groups of test nozzles and pens, and subsequently, reverse the paper to scan all the combined patterns.

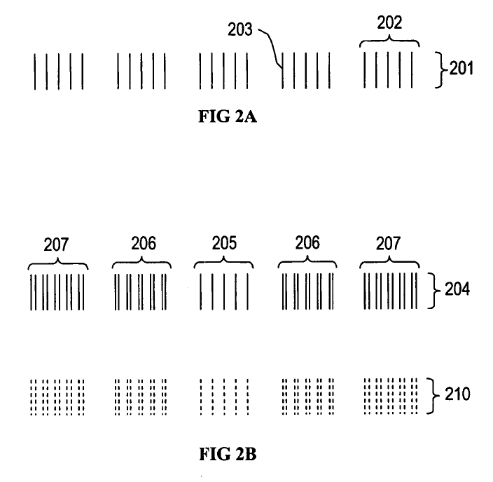

FIG. 2A shows the reference pattern 201 printed by the reference nozzles. The reference pattern 201 includes a series of blocks 202 of evenly spaced vertical lines 203. The offset pattern (not shown separately) is also a series of blocks of evenly spaced lines. The number of blocks of the reference pattern and the offset pattern is determined by a desired alignment range of the nozzles.

The centre block of the offset pattern is intended to align completely with the centre block of the reference pattern 201. Two blocks of the offset pattern which are adjacent to the centre block of the offset pattern are shifted by one column with respect to the respective corresponding adjacent blocks of the reference pattern 201. The two adjacent blocks of the offset pattern are shifted in a direction away from the centre block. Additionally, two further adjacent blocks of the offset pattern are shifted by two columns with respect to the respective corresponding further adjacent blocks of the reference pattern 201 in the direction away from the centre block.

The combined patterns 204, 210 for two different color pens are shown in FIG. 2B. The combined centre block 205 shows a completely aligned pattern in the case when there is no misalignment of the nozzles of the pens. The two blocks 206 adjacent to the centre block 205 show an offset of 1 column between the corresponding adjacent blocks of the reference pattern and the offset pattern. The two further adjacent blocks 207 show an offset of 2 columns between the corresponding further adjacent blocks of the reference pattern and the offset pattern.

It can be seen that when a block of the offset pattern is completely aligned with a block of the reference pattern, the corresponding combined pattern is the least dense compared to the case when a block of the offset pattern is offset from a block of the reference pattern. This is because the lines of the two blocks completely overlap each other, and hence, have a maximum amount of white space between them. When the offset between the blocks increases, the amount of overlapping of the lines, and hence, the amount of white space decreases. This also results in an optical density of the combined block to increase. The increase in the optical density of the combined blocks translates to a decrease in reflectivity.

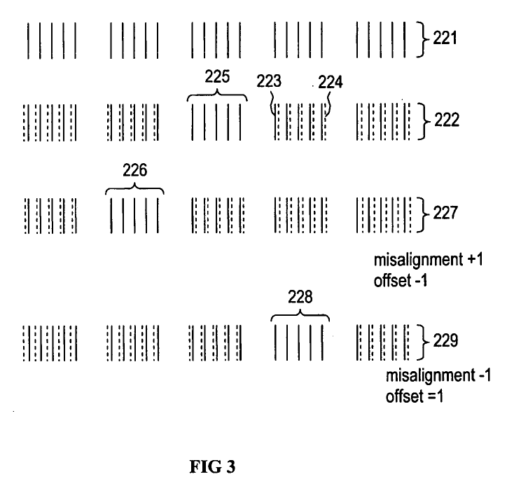

FIG. 3 illustrates a few examples of combined patterns. The reference pattern 221 printed by the reference nozzles comprises five blocks of evenly spaced lines. The offset pattern is printed by the test nozzles on the reference pattern 221 to form the combined pattern 222. The reference pattern 221 is represented by solid vertical lines 223 and the offset pattern is represented by dotted vertical lines 224.

When the test nozzles are completely aligned with the reference nozzles, the centre block 225 of the combined pattern 222 is the best aligned block. However, when the test nozzles have misalignment of one column to the right (misalignment value of +1), the adjacent block 226 to the left of the centre block 225 becomes the best aligned block of the combined pattern 227. In this case, the test nozzles are aligned to be reference nozzles by offsetting the test nozzles by one column to the left (offset value of −1).

When the test nozzles have misalignment of one column to the left (misalignment value of −1), the adjacent block 228 to the right of the centre block 225 becomes the best aligned block of the combined pattern 229. In this case, the test nozzles are aligned to the reference nozzles by offsetting the test nozzles by one column to the right (offset value of +1).

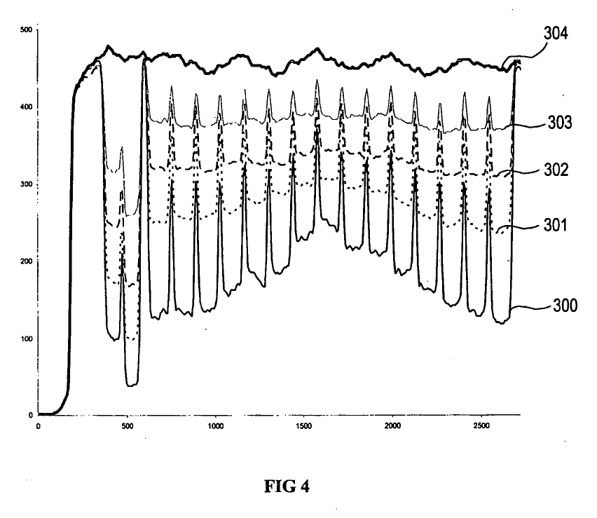

FIG. 4 shows a graphical representation of the reflectivity of the combined patterns of the four different color (black, yellow, magenta and cyan) pens 300, 301, 302, 303. The reflectivity of the paper 304 is also shown in the same graph. The best aligned block (having the highest reflectivity) for the black pen 300 and the yellow pen 301 can be detected easily by the optical scanner. However, the best aligned block for the magenta pen 302 and the cyan pen 303 is obscured by the variation in the paper reflectivity due to the variation of the paper thickness. Another reason that the detectability of the reflectivity of the magenta and cyan pens 302, 303 is difficult is due to the use of the blue LED in the optical scanner. The color of blue is very close to the color of magenta and cyan, making the magenta and cyan ink difficult to detect.

By obtaining the difference in reflectivity between the reference pattern and the combined pattern, the variation in the paper reflectivity is removed. FIG. 5 shows a graphical representation of the reflectivity of the reference pattern printed by the cyan pen 401, the reflectivity of the combined pattern printed by the cyan pen 402, the difference in reflectivity 403 between the combined pattern 402 and the reference pattern 401, and the reflectivity variation due to paper 404.

It can be seen that the difference in reflectivity 403 between the combined pattern 402 and the reference pattern 401 of the cyan pen is a slight V-shape curve. The shape of the curve can be seen more evidently by scaling the curve.

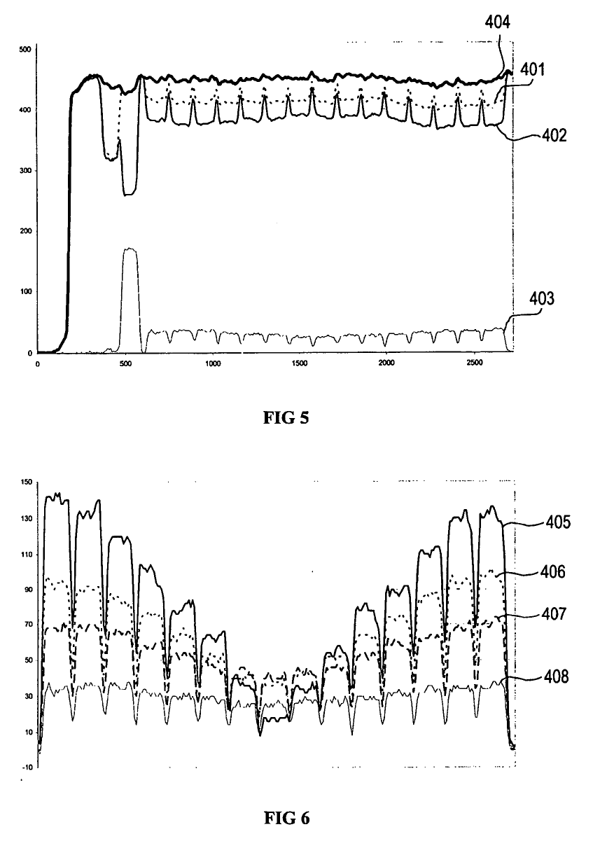

FIG. 6 shows a graphical representation of the difference in reflectivity between the combined pattern and the reference pattern of the black, yellow, magenta and cyan color pens 405, 406, 407, 408. The block corresponding to the best aligned block can now be detected for each pen. The best aligned block for each pen corresponds to the lowest value of the difference in reflectivity.

It is also possible to represent the difference in reflectivity of one or more pens using a suitable curve. A suitable curve would be a second order polynomial curve. The block corresponding to a minimum point of the second order polynomial curve is determined as the best aligned block for the pen.

Although it has been described that the reflectivity variation of the paper is removed by obtaining the difference in reflectivity between the combined pattern and the reference pattern, it is also possible to remove the reflectivity variation of the paper by first scanning the paper reflectivity and removing it subsequently.

In another embodiment, the test nozzles of each pen are aligned to the reference nozzles of the same pen by first scanning the paper to determine the reflectivity variation of the paper. The reference pattern and the offset pattern are printed by the reference nozzles and the test nozzles, respectively, to form the combined pattern. A difference in reflectivity between the combined pattern and the paper is obtained. Finally, the test nozzles are aligned to the reference nozzles. based on the obtained difference in reflectivity between the combined pattern and the paper.

In another embodiment, one inkjet pen (referred to as test pen) is aligned to another inkjet pen (referred to as reference pen). This type of alignment is called Inter-Pen or Pen-to-Pen alignment.

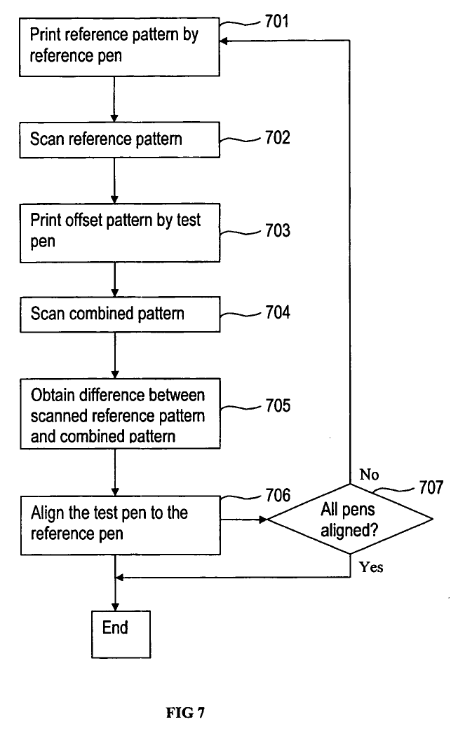

FIG. 7 shows a flow chart of an embodiment for Inter-Pen alignment. Step 701 includes printing a reference pattern on the paper using the reference pen. Step 702 includes scanning the reference pattern using the optical scanner to determine the reflectivity of the reference pattern. Step 703 includes printing an offset pattern on the paper by the test pen. The offset pattern coincides with the reference pattern to form a combined pattern. Step 704 includes scanning the combined pattern using the optical scanner to detect the reflectivity of the combined pattern.

Step 705 includes obtaining a difference in reflectivity between the reference pattern and the combined pattern. The difference in reflectivity can be obtained by subtracting the reflectivity of the combined pattern from the reference pattern. Step 706 includes aligning the test pen to the reference pen based on the difference in reflectivity between the reference pattern and the combined pattern. The test pen is aligned to the reference pen in the same way of aligning the test nozzles to the reference nozzles of an inkjet pen.

Step 707 includes determining whether all the inkjet pens are aligned. If not all the pens are aligned to the reference pen, steps 701 to 706 are repeated for another pen as the test pen.

Similarly, it is also possible to print all the combined patterns for all the pens, and subsequently, reverse the paper to scan all the combined patterns.

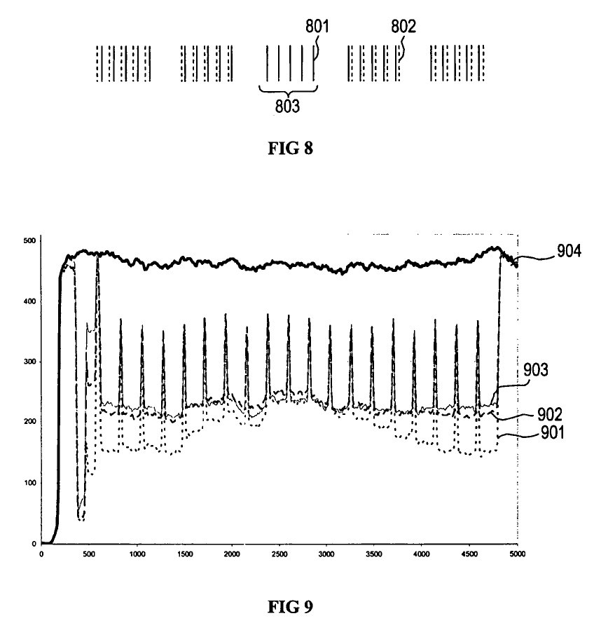

FIG. 8 shows an example of a combined pattern printed by the reference pen and the test pen. The solid vertical lines 801 represent the reference pattern, and the dotted vertical lines 802 represent the offset pattern. The centre block 803 of the offset pattern is intended to completely align the centre block of the reference pattern. When the test pen is completely aligned to the reference pen, the centre block 803 corresponds to the best aligned block of the combined pattern.

FIG. 9 shows a graphical representation of the reflectivity of the combined patterns of the different color test pens: yellow 901, magenta 902 and cyan 903. The reflectivity of the paper 904 is also shown in the same graph. The best aligned block for the magenta pen 902 and the cyan pen 903 are obscured by the reflectivity variation of the paper 904, but can be detected easily after obtaining the difference in reflectivity in step 705 described earlier.

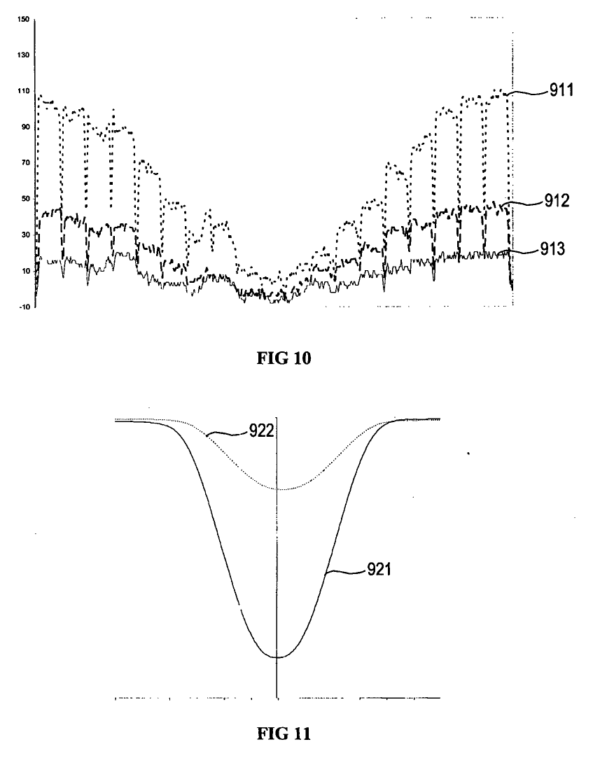

FIG. 10 shows a graphical representation of the difference in reflectivity for each test pen: yellow pen 911, magenta pen 912 and cyan pen 913. It can be seen that the shape of the difference in reflectivity for each pen is evident, and the best aligned block of the combined patterns corresponding to each test pen can be determined. The difference in reflectivity for each pen may also be represented using a suitable curve, in particular, a second order polynomial curve.

Similarly, it is also possible to remove the reflectivity variation of the paper by first scanning the paper reflectivity, and removing it subsequently. In another embodiment, the test pen is aligned to the reference pen by first scanning the paper to determine the reflectivity variation of the paper. The reference pattern and the offset pattern are printed by the reference pen and the test pen, respectively, to form the combined pattern. A difference in the reflectivity between the combined pattern and the paper is obtained. Finally, the test pen is aligned to the reference pen based on the obtained difference in reflectivity between the combined pattern and the paper.

In the above-described embodiments, the optical scanner scans the reference patterns and the combined patterns to detect the optical density of the patterns. Therefore, the scanning of the reference patterns and the combined patterns is not limited by the resolution of the optical scanner, which is normally at 600 dpi (dots per inch). Accordingly, the patterns can be printed at a high resolution such as at 1200 dpi or even 2400 dpi on coated media, and alignment of the nozzles and pens can be performed at the printed resolutions without any extrapolations.

Furthermore, the embodiments as described above allow a high resolution alignment process to be implemented using a low-cost printer. This is because only a low-cost single-color LED optical sensor instead of a multi-color LED optical sensor is needed in the optical scanner of the printer for the high resolution alignment process.

The accuracy of the alignment process described in the above embodiments can be further improved by printing the reference patterns and the offset patterns over the same area several times. This increases the optical density of the patterns, and hence, results in greater contrast between the reflectivity of the patterns and the paper. Also, the patterns can be printed over a large portion of the paper to average out the reflectivity variations due to the thickness variation of the paper.

The causes of misalignment between inkjet pens include carriage mounting, vibration due to carriage movement, carriage speed, manufacturing tolerance and printhead seating. Such misalignments could be large. Accordingly, a pre-alignment stage is performed to pre-align the test nozzles/pen to the reference nozzles/pen in an embodiment to increase the alignment range for aligning the test nozzles/pen to the reference nozzles/pens. Therefore, large misalignments of the nozzles/pens can be detected and corrected.

In an embodiment for pre-aligning the cyan pen to the black pen, the combined pattern 204 printed by the black pen and the combined pattern 210 printed by the cyan pen, as shown in FIG. 2B, are scanned in a first step. It is to be noted in this case that the Intra-Pen alignment is normally performed prior to the Inter-Pen alignment. Therefore, the combined patterns 204, 210 of the black and cyan pens are already printed on the paper. If the combined patterns 204, 210 are not printed, they can be printed on the paper prior the pre-alignment stage.

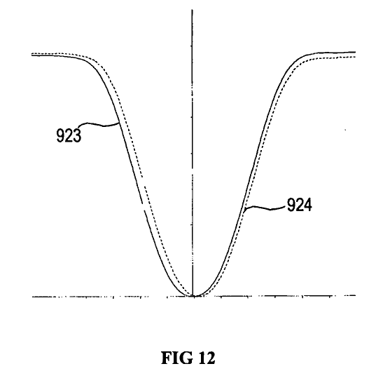

The scanning of the combined patterns 204, 210 detects the edges of the blocks in the patterns to form a series of pulses for each pen. Each pulse corresponds to a block in the combined pattern. In a second step, all the pulses for each pen are summed to form a “super-bar”. FIG. 11 shows a graph depicting two super-bars corresponding to the black pen 921 and the cyan pen 922.

In a third step, the two super-bars are scaled to a same scale for easy comparison. The scaled super-bars are shown in FIG. 12. It can be seen from the graph of FIG. 12 that there is an offset between the scaled superbars of the black pen 923 and the cyan pen 924. The amount of misalignment between the two pens is determined based on the offset between the two scaled superbars 923, 924, and the cyan pen is pre-aligned to the black pen accordingly. After pre-aligning the cyan pen to the black pen, the alignment process as described by the flowchart of FIG. 7 is performed to align the cyan pen to the black pen.

Aliasing effects may affect the accuracy of the alignment process described in the above embodiments. Assuming that the lines of each block of the reference patterns and offset patterns are spaced 10-column apart, a determined misalignment of 1 column of the test nozzles/pen may in fact be 11 columns, 21 columns, 31 columns and so on. This is called aliasing effect. Aliasing effects are normally assumed to be negligible. The detection of aliasing effect according to an embodiment can be illustrated with an example for aligning two pens.

The reference pattern and offset pattern are printed with the lines in each block evenly spaced at 10-column apart. The misalignment of the test pen is assumed to be determined as +1. The test pen is offset by a value of −1accordingly to be aligned to the reference pen. A new reference pattern and a new offset pattern are then printed with the lines in each block evenly spaced at 11-column apart to form a new combined pattern. The misalignment of the test pen is again determined based on the new combined pattern.

If the actual misalignment of the test pen is +1, the test pen would be completely aligned to the reference pen when being offset by −1. Hence the misalignment determined based on the new combined pattern will be zero. However, if the actual misalignment of the test pen is +11, the test pen would still be misaligned from the reference pen by +10 even when offset by −1. Hence, when the new reference pattern is printed (e.g. at column number 0, 11, 22, etc), the new offset pattern would be 1 column to the left of the new reference pattern (i.e. at column number −1, 10, 21, etc). Therefore, the misalignment determined based on the new combined pattern would be −1. Similarly in the case when the actual misalignment of the test pen is +21, the misalignment determined based on the new combined pattern would be −2. Accordingly, the aliasing effects can be detected based on the misalignment determined from the new combined pattern.

In an embodiment, a further reference pattern and a further offset pattern are printed by the test nozzles/pen and the reference nozzles/pen, respectively, to form a further combined pattern. The lines in the blocks of the further reference pattern and the further offset pattern are evenly spaced at a distance different from that of the reference pattern and the offset pattern. An offset value is determined based on the further combined pattern. The determined offset value is used to determine the misalignment of the test nozzles/pen from the reference nozzles/pen, and hence, the amount of offset required to align the test nozzles/pen.

Different types of print media have different ink absorption characteristics. The quality of paper also affects its ability to hold ink. A good quality paper is able to retain ink well, and ink printed on a poor quality paper may diffuse on the paper. Therefore, thinner lines are normally used for printing on poor quality paper as compared to printing on good quality paper to prevent the diffusion of ink to fill up the gaps between the lines.

In an embodiment, a most misaligned combined pattern with varying line thickness is printed on a paper. The most misaligned combined pattern is scanned using an optical scanner to determine a threshold thickness value when the gaps between the lines are filled up, that is when a reading from the optical scanner becomes constant. On a white paper, when the white space (or the gap) between the lines are large, the reading from the optical scanner is high. However, when the white space decreases (due to the use of thicker lines), the readings from the optical scanner decreases. When all the white spaces are filled up, the reading from the optical scanner becomes constant. The thickness of the lines when the reading of the optical scanner decreased to a constant value is the determined threshold thickness value. Based on the determined threshold thickness value, the optimal line thickness for printing on the paper is determined accordingly.

Although the present invention has been described in accordance with the embodiments as shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

1. A method for aligning a plurality of ink ejecting elements in an image forming device, comprising:
printing a reference pattern onto a first portion of a print medium by a first ink ejecting element;
printing an offset pattern onto a second portion of the print medium by a second ink ejecting element, wherein the first portion coincides with the second portion, thereby forming a combined pattern;
scanning at least a portion of the combined pattern to generate a first response; and
removing print medium noise from the first response, thereby generating a second response, wherein the print medium noise corresponds to a thickness variation of the print medium,
wherein the second ink ejecting element is aligned to the first ink ejecting element of the image forming device based on the second response.

2. The method of claim 1, further comprising scanning at least a portion of the reference pattern prior to printing the offset pattern to generate a reference pattern response.

3. The method of claim 2, wherein the print medium noise is removed from the first response by obtaining a difference between the reference pattern response and the first response, thereby generating the second response.

4. The method of claim 1, further comprising scanning the first portion of the print medium prior to printing the reference pattern to obtain a print medium response.

5. The method of claim 4, wherein the print medium noise is removed from the first response by obtaining a difference between the print medium response and the first response, thereby generating the second response.

6. The method of claim 1, wherein aligning the second ink ejecting element to the first ink ejecting element comprises
determining a position corresponding to a lowest value of the second response;
determining an offset value which corresponds to a difference between the position of the lowest value of the second response and the position of a theoretical lowest value of the second response, wherein the offset value is used to align the second ink ejecting element to the first ink ejecting element.

7. The method of claim 6, wherein the second response is represented using a graphical representation, and a minimum point of the graphical representation of the second response is determined as the lowest value of the second response.

8. The method of claim 1, wherein the reference pattern and the offset pattern each comprises a series of blocks, each block comprises a plurality of lines which are evenly spaced apart at a predetermined distance.

9. The method of claim 8, wherein one block of the offset pattern is intended to completely align a corresponding block of the reference pattern, and the other blocks of the offset pattern are selectively shifted relative to the other respective corresponding blocks of the reference pattern, thereby forming a series of combined blocks of the combined pattern.

10. The method of claim 9, wherein the first response is generated from the scanning of the combined pattern by detecting an optical density of each combined block of the combined pattern.

11. The method of claim 10, further comprising
printing a further reference pattern onto a third portion of the print medium by the first ink ejecting element;
printing a further offset pattern onto a fourth portion of the medium by the second ink ejecting element, the third portion coincides the fourth portion, thereby forming a further combined pattern, wherein the further reference pattern and the further offset pattern each comprises a series of blocks, and each block comprises a plurality of lines which are evenly spaced apart at a further predetermined distance which is different from the predetermined distance of the evenly spaced lines in each of the blocks of the reference pattern and the offset pattern;
scanning the further combined pattern to generate a third response, wherein the third response is used to determine whether a further alignment of the second ink ejecting element to the first ink ejecting element is needed.

12. The method of claim 11, wherein one block of the further offset pattern is intended to completely align L corresponding block of the further reference pattern, and the other blocks of the further offset pattern are selectively shifted relative to the other respective corresponding blocks of the further reference pattern, thereby forming a series of combined blocks of the further combined pattern.

13. The method of claim 12, wherein the third response is generated from the scanning of the further combined pattern by detecting an optical density of each combined block of the further combined pattern.

14. The method of claim 1, further comprising a pre-alignment stage to align the second ink ejecting element to the first ink ejecting element, the pre-alignment stage comprising:
printing a first pre-alignment pattern on a third portion of the print medium by the first ink ejecting element;
printing a second pre-alignment pattern on a fourth portion of the print medium by the second ink ejecting element, wherein the third portion of the print medium is different from the fourth portion of the print medium;
scanning the first pre-alignment pattern to generate a first pre-alignment response;
scanning the second pre-alignment pattern to generate a second pre-alignment response;
aligning the second ink ejecting element to the first ink ejecting element based on the first pre-alignment response and the second pre-alignment response.

15. The method of claim 14, wherein the first pre-alignment pattern and the second pre-alignment pattern each comprises a series of blocks.

16. The method of claim 15, wherein the scanning of the first pre-alignment pattern comprises
detecting an edge of each block of the first pre-alignment pattern to form a first series of edge responses; and
superimposing the edge responses to form the first pre-alignment response.

17. The method of claim 15, wherein the scanning of the second pre-alignment pattern comprises
detecting an edge of each block of the second pre-alignment pattern to form a second series of edge responses; and
superimposing the edge responses to form the second pre-alignment response.

18. A system for aligning a plurality of ink ejecting elements in an image forming device, the system comprises:
a controller operable to control a first ink ejecting element to print a reference pattern onto a first portion of a print medium, and to control a second ink ejecting element to print an offset pattern onto a second portion of the print medium, wherein the first portion coincides with the second portion, thereby forming a combined pattern;
an optical scanner configured to scan at least a portion of the combined pattern to generate a first response; and
a processor configured to remove print medium noise from the first response, thereby generating a second response,
wherein the print medium noise in the first response corresponds to a thickness variation of the print medium; and
wherein said controller being configured to align the second ink ejecting element to the first ink ejecting element based on the second response.

19. The system of claim 18, wherein the ink forming device is an ink-jet printer.

20. The system of claim 19, wherein the plurality of ink ejecting elements corresponds to a plurality of ink-jet printheads or a plurality nozzles of an ink-jet printhead.

21. A program storage device readable by a computing device, tangibly embodying a program of instructions, executable by the computing device to perform a method for aligning a plurality of ink ejecting elements in an image forming device, the method comprising:
printing a reference pattern onto a first portion of a print medium by a first ink ejecting element;
printing an offset pattern onto a second portion of the print medium by a second ink ejecting element, wherein the first portion coincides with the second portion, thereby forming a combined pattern; and
scanning at least a portion of the combined pattern to generate a first response;
removing print medium noise from the first response, thereby generating a second response, wherein the print medium noise corresponds to a thickness variation of the print medium,
wherein the second ink ejecting element is aligned to the first ink ejecting element of the image forming device based on the second response.
